(19) United States
(12) Patent Application Publication
(10) Pub. No.: US 2010/0183894 A1
(43) Pub. Date: Jul. 22, 2010

(54) METHOD FOR COATING A CONSTRUCTION MATERIAL WITH A FUNCTIONAL METAL AND THE PRODUCT MANUFACTURED BY THE METHOD

(75) Inventors: Olli Hyvärinen, Pori (FI); Pekka Taskinen, Pori (FI); Mari Lindgren, Pori (FI)

Correspondence Address: CHERNOFF, VILHAUER, MCCLUNG & STENZEL, LLP, 601 SW Second Avenue, Suite 1600, PORTLAND, OR, 97204-3157, US

(73) Assignee: OUTOTEC OYJ, Espoo (FI)

(21) Appl. No.: 12/665,707

(22) PCT Filed: Jun. 18, 2008
(86) PCT No.: PCT/FI2008/050373

§ 371 Date: Mar. 8, 2010

(30) Foreign Application Priority Data
Jun. 20, 2007 (FI) 20070490

(51) Int. Cl. B32B 15/01; C25D 5/02; B32B 15/02; B32B 15/18; C25D 7/00; C25D 7/06

(52) U.S. Cl. 428/613; 205/112; 205/50

(57) ABSTRACT

A method for coating a construction material made of metal alloy with a functional metal. The functional metal is deposited electrolytically on the surface of the construction material selectively so that the deposition occurs on the grain boundaries of the construction material and other points of discontinuity. The invention also relates to a construction material product, which is selectively coated with a functional metal.

### FIELD OF THE INVENTION

The invention relates to a method for selectively coating a construction material made of an iron-based metal alloy with a functional metal. The coating method includes selective coating with an electrochemical deposition method. It is typical of the method that the functional metal is deposited essentially on the grain boundaries of the iron-based metal alloy. The invention also relates to an iron-based construction material product, which is selectively coated with a functional metal.

### BACKGROUND OF THE INVENTION

Nowadays, attempts are being made to attain even more value-adding features for the surface of construction materials, such as stainless steel, such as for example permanent cleanliness, scratch resistance or anti-bacterial property. Stainless steel or another iron-based construction material such as carbon steel is not anti-bacterial in itself. The anti-bacterial property i.e. the property of killing bacteria and microbes and suppressing their proliferation, is however a characteristic that raises interest, because of the awareness of food poisoning epidemics and the appearance of new hospital bacteria that are resistant to antibiotics. The anti-bacterial property is generated in stainless steel by means of a functional metal. For example, silver ions and copper ions have a bacteria-killing effect.

When processing stainless steel for instance, more important questions with regard to treatment include corrosion-resistance and the permanence of the properties for manufacturing as well as the preservation of the valued outward appearance of steel.

When stainless steel or some other iron-based alloy is treated to become anti-bacterial, applications for it can be found in health care, the food industry, the construction industry, public buildings and consumer products. Anti-bacterial products in the hospital environment include furniture and fittings; in the food industry walls and surfaces can be anti-bacterial. Air conditioning pipes and other products that are difficult to clean are suitable applications for anti-bacterial materials. As for consumer products, anti-bacterial materials are found mostly in products connected with food, such as ice-makers and refrigerators.

Functional metals can be arranged in the following order in accordance with the strength of their anti-bacterial property:

### Hg>Ag>Cu>Ni>Zn>Fe etc.

Mercury is a heavy metal and a strong poison, which is why its use is avoided. Silver has excellent anti-bacterial properties and the silver content required is very small. In addition, it is not harmful to the human body. Copper is another metal that has good anti-bacterial properties and additionally is considerably less expensive in price than silver. Nickel is allergenic, so its use if fairly limited. Therefore silver and copper are the most interesting metals for forming an anti-bacterial surface.

As is well known, stainless steel can be made anti-bacterial by two principles i.e. either by alloying the steel with a functional metal or coating the alloy with the metal in question.

Alloying steel with silver or copper is known in the prior art, for instance in U.S. Pat. Nos. 6,391,253 and 6,312,533. The alloying of copper with stainless steel is not however sufficient on its own, because generally there is a passive film on the surface of the steel, which separates the copper from the bacteria. Copper therefore has to be made to enrich the passive film, which can be implemented either by heat treatment or by electrochemical pickling. In that case it becomes problematic that, when the copper precipitates as a less noble substance are corroded away over time, the passive film becomes discontinuous, whereby the risk of pitting is increased. When silver is used as the alloying element of the steel, less of it is required, so that the equivalent risk of pitting does not occur. On the other hand, silver is distributed in the alloying evenly throughout the thickness of the material and does not particularly enrich the vicinity of the surface, where it would be needed. This means that the use of silver is not effective, which when taking into account the price of silver also raises the price of the end product.

In another solution known in the prior art, a coating is used on top of stainless steel. This kind of solution is described e.g. in WO patent applications 2006126823 and 03/056924. The silver ions in the product in accordance with the latter publication are in a zeolite matrix, which is is dispersed into a polymer. The idea of zeolite is that silver ions are released more when the conditions are beneficial for rapid bacterial growth, such as for instance in damp conditions. Since the anti-bacterial effect works only when needed, the life of the product is extended considerably. The drawback of the method is that the product no longer looks like stainless steel. In addition, the coating may cause problems in forming or welding.

In the 1990s, superfilling coating was developed for the needs of the electronics industry to even out the irregularities on the surface of copper printed circuit boards and thus improve electrical conductivity. A copper seed layer is used in circuit boards, on top of which a superfilling coating is made.

In this method, copper is deposited more strongly on the grooves of the circuit board, filling them, whereas there is little deposition on the face area. Copper deposition is regulated by means of additives used in the coating bath. The coating rate can be affected by a combination of additives with local variations. The coating method is described for example in the following article: Moffat, T. P. et al: “Superfilling and the Curvature Enhanced Accelerator Coverage Mechanism”, The Electrochemical Society Interface, Winter 2004, pp. 46-52.

### PURPOSE OF THE INVENTION

The purpose in accordance with this invention is to coat a construction material made of an iron-based metal alloy selectively with a functional material, whereby the amount of functional metal needed is smaller than that needed in ordinary alloying and at the same time the purpose is to preserve the typical outward appearance of the construction material such as stainless steel.

### SUMMARY OF THE INVENTION

The invention relates to a method for coating a construction material made of an iron-based metal alloy with a functional metal, whereby the functional metal is selectively deposited electrolytically on the surface of an electroconductive construction material so that the deposition occurs on the grain boundaries of the construction material and on other points of discontinuity.

The construction material coated by the method accordant with the invention is an iron-based metal alloy. According to one embodiment of the invention the construction metal is stainless steel. According to another embodiment the construction material is carbon steel.

The functional metal to be deposited on the surface of the construction material is an anti-bacterial metal. The functional metal is typically silver and/or copper.

According to one embodiment of the invention, pickling is performed on the construction material formed from an iron-based metal alloy before the electrolytic deposition of the functional metal.

Preferably an additive used in the electrolytic deposition of the functional metal is at least one of the following: a suppressor, a catalyst, an inhibitor and a complexing agent.

According to one embodiment of the invention, in addition to the functional metal, a thin plastic/polymer coating is formed under or on top of it to improve the adhesive strength of the functional metal and therefore the chemically active coating thus produced. The polymer coating is preferably silane.

According to one embodiment of the invention, rolling is performed on the construction material on the surface of which the functional metal is deposited, in order to close the grain boundaries and achieve the desired hardness and quality.

The treatment of the construction material is carried out preferably on the reel-to-reel principle, when the construction material to be treated is in the form of a strip or wire. The coating of strip-like material is carried out on either one or both of the surfaces. When the construction material to be treated is in the form of a finished product, the coating treatment is preferably performed in a vertical position.

The relation also relates to the construction material product coated with a functional metal and made of a metal alloy, whereby the functional metal is deposited onto the surface of an electroconductive construction material in its grain boundaries and other points of discontinuity.

The construction material according to the invention is preferably an iron-based metal alloy. According to one embodiment of the invention the construction material is stainless steel. According to another embodiment of the invention the construction material is carbon steel.

The construction material according with the invention is in strip or wire form or a finished product. The coating of a strip-like material is performed on either one or both surfaces. The coating of a finished product is performed on at least one surface.

The functional metal used as the coating of the construction material accordant with the invention is an anti-bacterial metal. The functional metal is typically silver and/or copper.

According to one embodiment of the invention, in addition to the functional metal, a thin plastic/polymer coating is formed underneath or on top of it to improve the adhesive strength of the functional metal and therefore the chemically active coating thus produced. The polymer coating is preferably silane.

The essential features of the invention will be made apparent in the attached claims.

### LIST OF DRAWINGS

FIG. 1 presents a copper-coated sample examined using an optical microscope and a scanning electron microscope

FIG. 2 presents the chemical compositions of selected points determined by an EDS analyser, and

FIGS. 3-5 present silver-coated samples examined by optical microscope and scanning electron microscope.

### DETAILED DESCRIPTION OF THE INVENTION

The purpose of the selective coating method implemented according to the method and the coating produced on a construction material made of an iron-based metal alloy is to distribute and attach a functional metal in a controlled way and sufficiently evenly on macro-scale on the surface of a construction material such as a steel strip. Thereby simultaneously the functional metal is “stored” in the material structure to preserve the desired functional or anti-bacterial property essentially throughout the entire life cycle of the product.

The construction material to be formed from an iron-based metal alloy refers mostly to stainless steel and carbon steel. The functional metal refers to a metal that prevents or suppresses the growth of bacteria or the formation of biofilms on top of the construction material. Typical functional metals are silver and copper. Selective coating refers to the fact that only a small amount of the surface of the construction material is coated with a functional metal.

The purpose of the method according to the invention is to deposit a functional metal on the surface of a construction material, either into the grain boundaries or the points of discontinuity existing or purposely formed in the surface of the material. Grain boundaries are points of discontinuity in a material, where the nucleation of a coating is easier than in the centre of the grains. Points of discontinuity can be formed for instance by brushing the surface. For the sake of simplicity hereinafter the text will use the term grain boundaries, but it also refers to other points of discontinuity in a construction material.

The deposition of a functional metal into the grain boundaries gives the method and the product manufactured with the method many advantages. Firstly, the grain boundaries act as a kind of storage for the functional metal so that as the high points of the surface wear down the anti-bacterial properties are still not lost, because the functional metal is mainly in the grooves of the surface. Secondly, the relative proportion of grain boundaries is small, whereby little functional metal is required. The third advantage is that, because the amount of functional metal needed is small, it does not decisively change the appearance of the product or its properties for further processing. The purpose is that the functional metal is made to deposit only as individual crystals on the surface of the construction material and not on top of one another in a growing solid structure, as in the superfilling method.

The selective coating process of a construction material with a functional metal consists of several sub-processes. The production line in practice comprises interconnected, consecutive stages, which can be divided into sub-entities in terms of research and production.

First the desired surface texture is formed on the surface of the construction material, onto which the functional metal is mostly made to adhere. The surface texture is formed by “opening” the grain boundaries material to be coated by pickling or forming structural surface defects in the product by brushing for example. Pickling can be done separately in connection with coating or it can be part of the normal steel manufacturing process for example. The nucleation of the functional metal onto the surface of the construction material in electrochemical deposition can be controlled by means of the desired surface texture.

In addition to surface texture, surface-active additives known as such added to the coating electrolyte are used in the control of nucleation. The additives used are at least one of the following: a suppressor such as BTA (benzotriazole), a catalyst such as SPS (bis-(3-sodium sulfopropyl disulfide, Na₂[SO₃(CH₂)₃S₂]₂), an inhibitor such as PEG (polyethylene glycol) or a complexing agent such as citric acid, EDTA (ethylene diamine tetraacetic acid) or tartaric acid. Ordinary galvanotechnical coating electrolysis water-salt solutions can be used as coating electrolytes, such as sulphate- and nitrate-based solutions. Some alkali may also be present in a nitrate-based solution such as ammonia or potassium, so that in the electrolyte there is for example, in addition to silver nitrate, ammonium nitrate or potassium nitrate and ammonia or silver nitrate and nitric acid with tartaric acid as the complexing agent.

When the coated material is examined with an optical microscope, the material corresponds to an uncoated one and the spherical particles nucleated on the grain boundaries are only visible under a scanning electron microscope.

It has been shown in electrochemical measurements that, regardless of the additives, a functional metal, especially copper, will attempt to precipitate from solution primarily onto the surface of a construction material such as steel on top of copper that has already been precipitated and not on top of the steel. This is why coating has to be carried out so quickly, so that the growth stage of the copper nuclei i.e. their agglomeration on top of each other does not yet occur. This is also an advantage of the method, because in this way coating happens quickly. It has also been proved in tests that one significant factor in nucleation is current density. At sufficiently great current density, nucleation can be targeted only at the reactive points of the construction material, i.e. the grain boundaries. The selected coating current is so small that copper is unable to nucleate on flawless material i.e. the centre of the grains, but only on high-energy defects.

The coating of the construction material is implemented using an ordinary electrochemical deposition method, whereby the strip-like or wire-like material proceeds through the pickling bath in a flat configuration. The construction material to be coated acts as a cathode so that the selected functional metal is reduced electrolytically from a suitable salt solution onto the surface of the construction material. Typically the anode used is an insoluble anode. Coating is typically performed onto one of the surfaces of a strip-like construction material, but if necessary coating can be done on both sides of the strip. When the construction material is wire-like, obviously the coating is performed on the outer surface of the wire. The object to be coated may also be a finished product, in which case coating is done on at least one of its surfaces. If required the other surfaces can be treated to prevent the functional metal from adhering to the surface.

It is advantageous to the method according with the invention that the coated material is further rolled, whereupon the treatment closes the grain boundaries and simultaneously the surface is endowed with the desired quality and hardness. Rolling may also preferably be part of the normal treatment process of the construction material. When the material to be coated is strip-like or wire-like, it is characteristic of the method that it can be implemented advantageously using the reel-to-reel principle. The method operates at a reasonable production rate, with a strip speed of around 1-10 m/min. The method consists of sub-processes/stages known per se in the prior art, so their operational reliability has been tested earlier, but nevertheless the manner of combining the sub-processes to each other is new. When coating is performed on a finished product, the product is submerged in an electrolysis bath and electrolytic deposition is performed on at least one surface of the piece. If necessary, the other surfaces can be treated so that the functional metal is not deposited on them.

In addition to the above, the coating may comprise, in addition to the functional metal, a base or surface layer underneath or on top of it that is produced with the desired thin plastic/polymer coating, in order to improve the adhesive strength of the functional metal and the chemically active coating thus produced. The plastic/polymer layer is preferably of porous silane, which does not inhibit the action of the functional metal or affect the appearance of the material.

One embodiment of the invention is to form an anti-bacterial surface on the construction material by using both copper and silver as the functional metal. In this case first copper nuclei are deposited on the construction material in the way described before and then a silver layer on top of them. When the copper becomes the undermost layer, only a very small silver layer may be deposited, which nevertheless still improves the anti-bacterial properties of the construction material.

The invention also relates to a product, in which a functional metal layer is formed selectively on the surface of a construction material made of an iron-based metal alloy, where said layer is bound to the construction material particularly to its grain boundaries or other points of discontinuity in the surface.

Use/applications for the product according with the invention include:
applications requiring an antiseptic property, such as the food industry and hospitals, where there is a huge, continual requirement for cleanliness and demands for a high level of hygiene; in this case the functional additive is typically silver,
‘biofouling’ in process industries, typically in the wood processing industry, or in seawater conditions, where the functional additive is typically copper.

### EXAMPLES

### Example 1

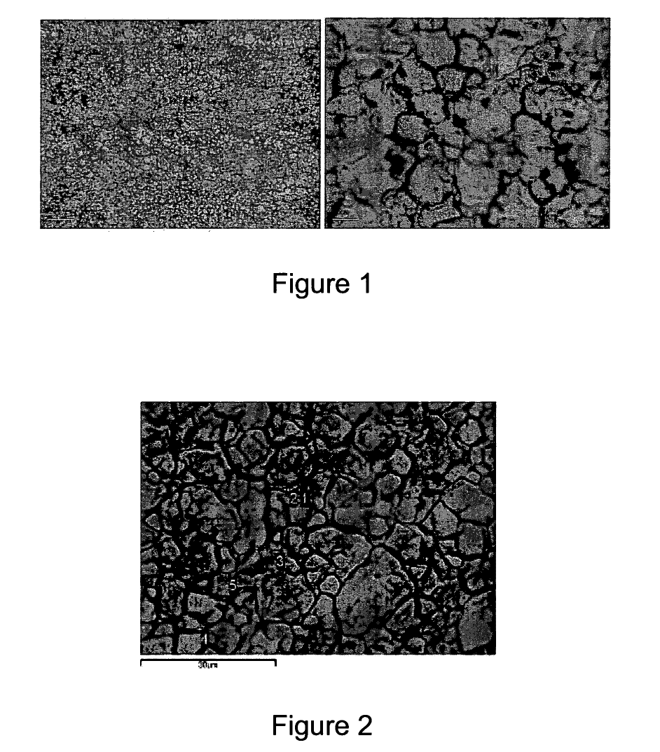

The nucleation of copper on the surface of stainless steel was affected mostly by the current density used in coating with a certain additive or additive combination. With a sufficiently great current density, nucleation can be made to occur on the most reactive points of the surface i.e. mostly on the grain boundaries. It was possible to regulate the growth of the nuclei and the copper content by means of the coating time. Coating times were very short (seconds), enabling a short throughput time in real production processes. On laboratory scale it was possible to produce the desired kind of microstructure reproducibly with selective deposition. FIG. 1 shows an example of a microstructure fabricated with a coating, and the element contents determined by scanning electron microscope, which verify that the copper appears in the desired place—on the grain boundaries. The AFM (Atomic Force Microscope) measurements support the conclusion that the copper has been placed mostly on the grain boundaries.

The chemical compositions of selected points determined by EDS analyser (Energy Dispersive Spectrometer) are shown with their analysis in FIG. 2:

| Spectrum | O | Al | Si | S | Cr | Mn | Fe | Ni | Cu |
|---|---|---|---|---|---|---|---|---|---|
| 1 | | 0.4 | 0.7 | 0.3 | 18 | 2 | 69 | 8 | 3 |
| 2 | | 0.4 | 0.5 | 0.1 | 9 | | 30 | 3 | 58 |
| 3 | 2 | 0.2 | 0.4 | | 18 | 2 | 66 | 8 | 4 |
| 4 | | 0.7 | 0.4 | 0.4 | 19 | 2 | 69 | 7 | 2 |
| 5 | | 0.3 | 0.3 | | 18 | 2 | 69 | 7 | 3 |

### Example 2

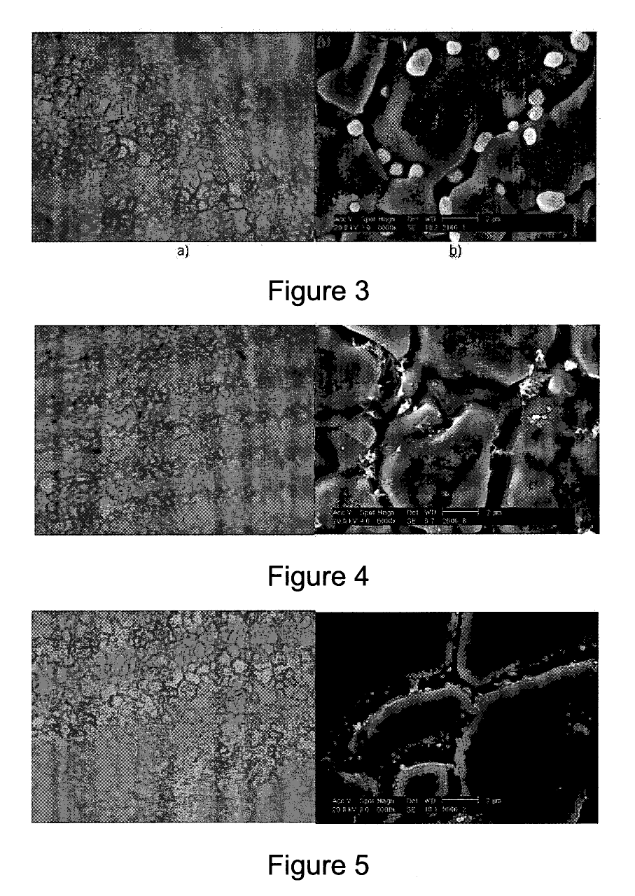

A large number of different types of coating baths and additives were tested in silver coating. The additives had a decisive effect on the way silver nucleated, which is shown in FIGS. 3-5. Silver nucleated either in spherical form or as filaments or very fine grains on and around the grain boundaries depending on the strength of the complexing agent used in the bath. The stronger the complexing agent used, the larger the silver particles that were nucleated. The images on the left were taken with an optical microscope and those on the right were taken with a scanning electron microscope (SEM).

1. A method for coating a construction material made of metal alloy with a functional metal, characterised in that the functional metal is deposited electrolytically on the surface of a construction material made of an iron-based alloy selectively so that the deposition occurs on the grain boundaries of the construction material and other points of discontinuity.

2. A method according to claim 1, characterised in that the construction material is stainless steel.

3. A method according to claim 1, characterised in that the construction material is carbon steel.

4. A method according to claim 1, characterised in that the functional metal is an anti-bacterial metal.

5. A method according to claim 4, characterised in that the functional metal is silver and/or copper.

6. A method according to claim 1, characterised in that pickling is performed on the electroconductive construction material before the electrolytic deposition of the functional metal.

7. A method according to claim 1, characterised in that at least one of the following group is used as an additive in the electrolytic deposition: a suppressor, catalyst, inhibitor and complexing agent.

8. A method according to claim 1, characterised in that in addition to the functional metal, a thin plastic/polymer coating is formed underneath or on top of it in order to improve the adhesive strength of the functional metal and the chemically active coating thus produced.

9. A method according to claim 8, characterised in that the polymer coating is silane.

10. A method according to claim 1, characterised in that the construction material, on the surface of which a functional metal is deposited, is subjected to rolling in order to close the grain boundaries and achieve the desired strength and quality.

11. A method according to claim 1, characterised in that coating of the construction material is performed on the reel-to-reel principle.

12. A method according to claim 11, characterised in that the construction material is in the form of strip or wire.

13. A method according to claims 1 and 12, characterised in that the coating of the strip-like construction material is carried out either on one or both surfaces of the strip.

14. A method according to claim 1, characterised in that the coating of the construction material is performed on at least one surface of a finished product.

15. A construction material product made of a metal alloy, coated with a functional metal, characterised in that the functional metal is deposited on the grain boundaries and other points of discontinuity on the surface of the construction material made of an iron-based metal alloy.

16. A product according to claim 15, characterised in that the construction material is stainless steel.

17. A product according to claim 15, characterised in that the construction material is carbon steel.

18. A product according to claim 15, characterised in that the functional metal is an anti-bacterial metal.

19. A product according to claim 18, characterised in that the functional metal is silver and/or copper.

20. A product according to claim 15, characterised in that the construction material is in strip or wire form.

21. A product according to claims 15 and 20, characterised in that the coating of a strip-like construction material is made on either one or both surfaces of the strip.

22. A product according to claim 15, characterised in that the coating is made on at least one surface of a finished product.

23. A product according to claim 15, characterised in that in addition to the functional metal, a thin plastic/polymer coating is formed underneath or on top of it in order to improve the adhesive strength of the functional metal and the chemically active coating thus produced.

24. A product according to claim 23, characterised in that the polymer coating is silane.
